(19) United States
(12) Patent Application Publication
(10) Pub. No.: US 2018/0213730 A1
(43) Pub. Date: Aug. 2, 2018

(54) BIO-POLYMER MULCH FILM AND PROCESS FOR MANUFACTURING SAME

(71) Applicant: 9298-6876 QUÉBEC INC., LAVAL (CA)

(72) Inventors: ROGER TAMBAY, DOLLARD-DES-ORMEAUX (CA); HUGO MEUNIER, LAVAL (CA)

(21) Appl. No.: 15/531,084

(22) PCT Filed: Oct. 21, 2016
(86) PCT No.: PCT/CA2016/051226

§ 371 Date: May 26, 2017

Related U.S. Application Data
(60) Provisional application No. 62/244,268, filed on Oct. 21, 2015.

(51) Int. Cl. A01G 13/02; C08J 7/04; C09D 11/102; C09D 11/14; C09D 11/037; C09D 11/12

(52) U.S. Cl. CPC A01G 13/0275; C08J 7/047; C09D 11/102; C09D 11/14; C08J 2477/00; C09D 11/12; C08J 2367/02; C08J 2367/04; C08J 2401/18; C09D 11/037

(57) ABSTRACT

A process for manufacturing a bio-polymer mulch film is provided. The process comprises coating at least parts of a surface of a bio-polymer film with a functional material. The functional material may comprise a light absorber material, a light reflector material and/or a pigment.

### FIELD OF THE INVENTION

The present disclosure relates generally to bio-polymer mulch films. More specifically, the present invention relates to a bio-polymer mulch film coated with a functional material and its manufacturing process.

### BACKGROUND OF THE INVENTION

The use of mulch is widespread in agriculture. Such mulch includes for example polyolefin films (such as polyethylene films) and more recently, bio-polymer films. The use of bio-polymer mulch films is increasing because these are tilled into the soil after harvest and the micro-organisms biodegrade such films in the soil without adversely affecting the environment, for example, in accordance to the OK Biodegradable Soil specification as set out by Vinçotte (www.vincotte.com). In contrast, polyethylene films are removed from the field after harvest, using labour and machinery, and afterwards are generally disposed of in a landfill. Generally, functional materials are incorporated into the matrix of the film in order to increase its longevity and weatherability. Also, the thickness of the film can be increased for this purpose. Functional materials might also be incorporated into the matrix of the polymer film to impart it with the ability to absorb sunlight, totally or partially or stabilize the film by scavenging free radicals that are the result of photo/light-degradation.

Functional materials include for example materials having light absorber and/or light stabilizer capabilities. Typically, a mono-layer or multi-layer co-extrusion process is performed to incorporate the functional material into the film matrix. Addition of the functional material into the matrix of a relatively thicker polyethylene film is generally economically feasible. That is because polyethylene-based mulch films are relatively inexpensive, as are the functional materials.

Bio-polymer mulch films are known in the art. They include for example “black” bio-polymer mulch films, “white on black” bio-polymer mulch films and “white” mulch films.

Black bio-polymer mulch films are generally produced with polyester, manufactured from either renewable or non-renewable sources. Examples of such bio-polyesters (“bio-polyesters”) used in the manufacture of bio-polymer films include polybutylene adipate terephthalate (PBAT), polylactic acid (PLA), polyhydroxy alkanoate (PHA), polyhydroxy butyrate (PHB), polyhydroxybutyrate valerate (PHBv), polyhydroxy hexanoate (PHHx), polycaprolatam (PCL), polybutylene succinate (PBA), polybutylene succinate adipate (PBSA), either in pure or blended form, and with or without fillers such as calcium carbonate, hydrated magnesium silicate (talc), magnesium carbonate, calcium silicate, lignin, cellulose, thermoplastic starch, kaolin, powdered wood or other similar fibers and adjuncts.

Black bio-polymer films are generally not well suited to outdoor use because they rapidly deteriorate with time. For example, a 0.5 milli inch (“mil”) black mulch film comprised of a blend of PBAT/PLA/calcium carbonate is not suitable for use in New Jersey to grow staked tomatoes. The film becomes brittle and breaks down too quickly on top of the soil bed. It then tears because of the wind, or because workers step on the brittle and weak soil mulched soil-bed, causing weeds growth. Weeds end up competing for nutrients, water and sunlight against the tomato plants, ultimately crop yield is reduced.

A solution known in the art is the combined use of a light absorber and a light stabilizer, to form the mulch film. Indeed, it is generally known that the use of carbon black of fine particles size, for example, 4 to 12 nanometers, provides some improved weathering characteristics because carbon black absorbs light.

Nonetheless, even films pigmented with carbon black and stabilized do not exhibit sufficient weathering behavior, unless they have a thickness of at least 0.7 mil. More specifically, a 0.7 mil film comprising of PBAT, PLA and calcium carbonate must contain at least 3% of carbon black (w/w) of particle size between 10 and 12 nanometers plus stabilization (the “Reference Film”) in order to withstand 4 months outdoors in Florida, Arizona, northern Australia, or other warm climate regions and maintain at least 50% of its strength, as measured by a stress-strain curve.

Accordingly, bio-polymer films must be relatively thick and well stabilized in order to be sufficiently weatherable, for example, as a mulch film used to grow solanacees like tomatoes, bell peppers and eggplant, in Florida or other warm climate regions. This is often times an uneconomical solution since bio-polyesters are expensive materials.

White on black mulch films are used as crop production tools for so-called later plantings. For example, in New Jersey, growers will apply a white on black mulch film on the soil bed for peppers transplanted in mid-June so as to keep the temperature above the soil below 50° C. Using black films increases the likelihood that young transplants overheat and die, because the temperature above the black plastic and at or about the young plant can reach values as high as 65° C. or more. In Florida and Georgia, growers use a white on black mulch film when planting in July or August, for the same reasons.

White on black mulch films are generally manufactured using the co-extrusion process. One or more layers of white plastic are extruded simultaneously with one or more layers of black plastic. Normally, for a 1.0 mil polyethylene film, the total thickness of the white layer(s) is at least 0.6 mil, and optimally, 0.8 mil, whereas the remainder of the film is black. Furthermore, the white layer comprises at least 14% of titanium dioxide so as to properly mask the black layer, which comprises about 3% of carbon black.

In the case of bio-polyester films, the thickness is generally about 0.8 mil and optimally at least about 0.6 mil so as to reduce the total cost of the film. In the case of a 0.6 mil film, the white layer(s) optimally comprise of at least 14% titanium dioxide and has a total thickness of 0.48 mil whereas the remaining black layer(s) comprise 3% of carbon black (the “Reference Film 2”). In order to improve the weathering of white on black mulch films, a stabilizer is generally added. However, this is not always effective. An alternative solution is to increase the thickness of the films in order to maintain a sufficient resistance after at least 4 months of outdoor exposure, enabling it to be used as a mulch film for so-called long crops such as solanacees.

White mulch films are also known in the art. Various drawbacks are associated with their use. For instance, they are sometimes ineffective at weed control.

It has been observed that young plants, especially peppers, or tomatoes, that have grown less or about 30 centimeters high occasionally suffer from wooden stems because the white or white on black films reflect too much sun, and cause sun burning. It is believed that a hardened stem weakens the plant and reduces the overall quality of fruits generated, mostly in terms of fruit size and overall yield. This is because a side-shoot will grow under the hardened stem. So the plant grows wide, not high. The plant will therefore compete for sunlight and space with other plants in the surrounding area. Such plants are generally bushier, not taller.

This problem is probably caused by the amount of light reflected. Some manufacturers of white on black films tout as high as 55% right reflectance. Others use silver on black films to achieve an even higher reflectance of the films, and even lower soil temperatures. It is believed that a high degree of reflectance causes sunburn to the plant and a hardened stem. This phenomenon is exacerbated if the mulch film covered soil area adjacent to the plant is depressed so that more light is concentrated on the young plant, like a concave mirror. Normally, the bed is flat or convex; however, the shape of the bed is not perfectly controlled so it often occurs that the bed is concave in the area around the plant.

As indicated above, it has been noted that white and white on black, or silver on black mulch films maintain the temperature of the soil around the plant at a low level. Indeed, it appears that while such films constitute an effective means of reducing the temperature above the soil and avoid the oasis effect caused by black mulch films, they maintain the temperature below the soil at a level that is considered too low. This can slow down plant growth and delay the harvest by several days.

Applicant is aware of the following documents: U.S. Pat. No. 6,401,390, U.S. Pat. No. 8,686,080, U.S. Pat. No. 8,383,549, U.S. Pat. No. 8,372,418, U.S. Pat. No. 8,372,417, U.S. 2010-0229462, KR 2004-0071992, CN 203666067, JP 2004-089178, KR 2014-0117948, WO 2012/119195, a research paper by Kijchavengkul T. et al. published in March 2008, and a research paper by Siegenthaler K. O. et al. published on Jul. 28, 2011.

Accordingly, there is a need for more efficient bio-polymer mulch films, i.e., bio-polymer mulch films having a better longevity and weatherability. Also, there is a need for more cost-effective processes for the manufacture of bio-polymer mulch films.

### SUMMARY OF THE INVENTION

The inventors have discovered a process for manufacturing a bio-polymer mulch film that involves use of smaller amounts of bio-polymer material and functional material. The process of the invention comprises a coating process. More specifically, the process of the invention comprises providing a coat of functional material on at least parts of a surface of a bio-polymer film.

The functional material may be a light absorber material, a reflective pigment, or any suitable similar material, or a combination thereof. More specifically, the functional material may be selected from the group consisting of: titanium dioxide (TiO₂), carbon black, finely ground aluminum, graphene, magnesium carbonate, zinc oxide, calcium carbonate, kaolin, or any suitable similar material, or a combination thereof.

The bio-polymer mulch film of the invention has an average thickness that is smaller than the thickness of a conventional mulch film. More specifically, the bio-polymer mulch film of the invention has an average thickness that is at least about 15% less than the thickness of an uncoated bio-polymer mulch film or a conventional mulch film with similar efficiency. In embodiments of the invention the average thickness of the bio-polymer mulch film may be between about 0.3 to 3 milli inch (0.3 to 3 mil).

The bio-polymer mulch film and the functional material are each independently of various colors. The color may be white, black, silver, blue, gray, green, or any other suitable color, or a combination thereof. The bio-polymer mulch film may also have its natural color.

The invention thus provides for the following according to aspects thereof:

(1) A process for manufacturing a bio-polymer mulch film, comprising a step of coating at least parts of a surface of a bio-polymer film with a functional material.
(2) A process for manufacturing a bio-polymer mulch film, comprising: providing a film of bio-polymer material; and coating at least parts of a surface of the bio-polymer film with a functional material to obtain the bio-polymer mulch film.
(3) A process according to (1) or (2), wherein the coating step is performed by a technique selected from the group consisting of: flexographic printing, coil printing, screen printing, rotogravure, lithography, ink-jet, roll-to-roll deposition technique, spraying technique and combinations thereof.
(4). A process according to (1) or (2), wherein the coating step is performed by flexographic printing.
(5) A process according to any one of (1) to (4), further comprising a pre-treatment step wherein a charge is imparted on the surface of the bio-polymer film; optionally the pre-treatment step comprises at least of corona treatment, air plasma, flame plasma and chemical plasma system.
(6) A process according to any one of (1) to (5), further comprising a curing step; optionally, the curing step involves heat, UV light and/or an electron beam.
(7) A process according to any one of (1) to (6), wherein the functional material comprises a light absorber material, a light reflector material and/or a pigment.
(8) A process according to any one of (1) to (6), wherein the functional material comprises at least one of: nitrocellulose, polyamide, acrylic, polyurethane, rosin, titanium dioxide (TiO₂), barium sulfate (BaSO₄), carbon black, aluminum (Al), graphene, zein including genetically modified zein and non genetically modified zein, magnesium carbonate (MgCO₃), zinc oxide (ZnO), calcium carbonate (CaCO₃), kaolin, wax, a metallic pigment including an aluminum (Al) pigment (Grandal™ W170), and a solvent.
(9) A process according to any one of (1) to (6), wherein the functional material comprises nitrocellulose, polyamide, carbon black, wax and a solvent.
(10) A process according to any one of (1) to (6), wherein the functional material comprises nitrocellulose, polyamide, wax, TiO₂ and a solvent.
(11) A process according to any one of (1) to (6), wherein the functional material comprises at least one of: nitrocellulose, polyamide, polyurethane, rosin, acrylic, genetically modified zein and non genetically modified zein.
(12) A process according to any one of (1) to (6), wherein the functional material comprises genetically modified zein, BaSO₄, Al, and a solvent; optionally, the functional material comprises an Al pigment (Grandal W170).
(13) A process according to any one of (1) to (6), wherein the functional material comprises non genetically modified zein, BaSO₄, Al and a solvent; optionally, the functional material comprises an Al pigment (Grandal W170).
(14) A process according to any one of (1) to (6), wherein the functional material comprises zein including genetically modified zein and non genetically modified zein, BaSO₄, TiO₂ and a solvent.
(15) A process according to any one of (1) to (6), wherein the functional material comprises zein including genetically modified zein and non genetically modified zein, BaSO₄ and a solvent.
(16) A process according to any one of (1) to (6), wherein the functional material comprises at least one of TiO₂ and carbon black.
(17). A process according to any one of (9) to (16), wherein the functional material has a viscosity (Zahn Cup #2 EZ) between about 20 to 30 seconds, preferably about 23 to 28 seconds or about 25 to 30 seconds; optionally the solvent is added during the process to maintain the viscosity at a desired value.
(18) A process according to any one of (9) to (17), wherein the solvent comprises alcohol and/or water.
(19) A process according to any one of (1) to (18), wherein the coating is on the whole surface of the bio-polymer film.
(20) A process according to any one of (1) to (18), wherein the coating is in the form of one or more stripes on the surface of the bio-polymer film.
(21) A process according to (20), wherein the stripes are continuous or discontinuous.
(22) A process according to any one of (1) to (21), wherein the coating is of a color selected from the group consisting of: white, black, silver, blue, gray, green, yellow, orange, red and a combination thereof; optionally the color is matte (reflectance below 55%).
(23) A process according to any one of (1) to (21), wherein the coating has no color (no pigment).
(24) A process according to any one of (1) to (23), wherein the bio-polymer film is of a color selected from the group consisting of: white, black, silver, blue, gray, green, brown and a combination thereof.
(25) A process according to any one of (1) to (23), wherein the bio-polymer film has its natural color.
(26) A process according to any one of (1) to (21), wherein the coated side of the bio-polymer film and the coating are each of a different color.
(27) A process according to any one of (1) to (21), wherein the coated side of the bio-polymer film and the coating are of the same color.
(28) A process according to any one of (1) to (21), wherein the coated side of bio-polymer film has a color and the coating has no color (no pigment).
(29) A process according to any one of (1) to (21), wherein bio-polymer film has no color and the coating has a color.
(30) A process according to any one of (1) to (21), wherein bio-polymer film has no color and the coating has no color (no pigment).
(31) A bio-polymer mulch film obtained by the process as defined in any one of (1) to (30).
(32) A bio-polymer mulch film comprising a layer of bio-polymer material that is at least partially coated with a layer of a functional material.
(33) A bio-polymer mulch film according to (32), having an average thickness that is at least about 15% less than an average thickness of an uncoated bio-polymer mulch film.
(34) A bio-polymer mulch film according to (32), having an average thickness that is at least about 15% less than an average thickness of a conventional mulch film.
(35) A bio-polymer mulch film according to (32), having an average thickness that is between about 0.3 to 3 mil.
(36) A method of controlling the temperature of the soil and air around a plant, comprising using a bio-polymer mulch film comprising a layer of bio-polymer material that is at least partially coated with a layer of a functional material.
(37) A method of controlling the temperature of the soil and air around a plant, comprising using a bio-polymer mulch film obtained by the process as defined in any one of (1) to (30).
(38) A method of controlling the temperature of the soil and air around a plant, comprising using a bio-polymer mulch film as defined in any one of (31) to (35).
(39) A method according to any one of (36) to (38), wherein the use comprises covering the soil around the plant with the bio-polymer mulch film such that the surface of the mulch film having the coat of functional material is exposed to sunlight.
(40) A composition comprising genetically modified zein, BaSO₄, Al and a solvent; optionally, the functional material comprises an Al pigment (Grandal W170).
(41) A composition comprising non genetically modified zein, BaSO₄, Al and a solvent; optionally, the functional material comprises an Al pigment (Grandal W170).
(42) A composition comprising genetically modified zein, BaSO₄, TiO₂ and a solvent.
(43) A composition comprising non genetically modified zein, BaSO₄, TiO₂ and a solvent.
(44) A composition comprising non genetically modified zein, BaSO₄ and a solvent.
(45) A composition comprising genetically modified zein, BaSO₄ and a solvent.
(46) A composition comprising non genetically modified zein and a solvent.
(47) A composition comprising genetically modified zein and a solvent.
(48) A composition according to any one of (40) to (47), wherein the solvent comprises an organic solvent including alcohol and/or water; preferably the solvent comprises a C₁-C₁₂ linear, branched, saturated or unsaturated organic solvent and/or water; more preferably the solvent comprises a C₁-C₁₂ linear, branched, saturated or unsaturated alcohol and/or water; more preferably the solvent comprises n-propanol and/or water.
(49) A composition according to any one of (40) to (47), wherein the solvent is selected from the group consisting of: n-propanol, n-propyl acetate, methanol, ethanol, ethyl acetate, methyl acetate, methoxy propyl acetate, 3-propoxypropan-1-ol (Propasol™ P), diacetone alcohol, ethoxypropanol and combinations thereof.
(50) Use of a composition as defined in any one of (40) to (49), in the manufacture of a bio-polymer mulch film.
(51) Use according to (50), wherein at least part of the surface of the bio-polymer mulch film is coated with the composition.
(52) A process for preparing a composition comprising zein, BaSO₄, Al and a solvent, the process comprising:
(a) providing a solvent comprising an organic solvent including alcohol and/or water;
(b) mixing zein with a first part of the solvent of step (a) to obtain varnish zein;
(c) mixing Al pellets with a second part of the solvent of step (a) to obtain a dough;
(d) mixing the varnish zein obtained at step (b), BaSO₄, Al, the dough obtained at step (c) and a third part of the solvent of step (a) to obtain a concentrated mixture; and
(e) mixing the concentrated mixture obtained at step (d) with a fourth part of the solvent of step (a) to obtain the composition.
   (53) A process for preparing a composition comprising zein, BaSO₄, TiO₂ and a solvent, the process comprising:
(a) providing a solvent comprising an organic solvent including alcohol and/or water;
(b) mixing zein with a first part of the solvent of step (a) to obtain varnish zein;
(c) mixing a first part of the varnish zein obtained at step (b), BaSO₄ and TiO₂ to obtain a concentrated mixture; and
(d) mixing the mixture obtained at step (c), a second part of the varnish zein obtained at step (b) and a second part of the solvent of step (a) to obtain the composition.
   (54) A process according to (52) or (53), wherein the solvent is obtained by gently stirring alcohol and/or water, preferably at room temperature.
   (55) A process according to (52) or (53), wherein step (b) is carried out under gentle to moderate stirring, preferably until the varnish zein is a homogenous mixture.
   (56) A process according to (52), wherein step (c) comprises (c1) soaking the Al pellets into the solvent, preferably during a period of about 30 minutes, and (c2) subjecting the mixture to a gentle stirring; preferably steps (c1) and (c2) are carried out at room temperature.
   (57) A process according to (52), wherein step (d) comprises (d1) incorporating BaSO₄ into the varnish zein and dispersing at high speed, and (d2) adding the dough at moderate speed, preferably until the concentrated mixture is a homogenous; optionally, the temperature at step (d1) is maintained around about 50-55° C.
   (58) A process according to (52), wherein step (e) is carried out under gentle to moderate stirring.
   (59) A process according to (52) or (53), wherein zein is genetically modified zein or non genetically modified zein.
   (60) A process according to (52), wherein the Al pellets at step (c) comprise Grandal W170.
   (61) A process according to (52), wherein the Al at step (d) comprises finely grounded Al.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Cross-section of an embodiment of the bio-polymer mulch film according to the invention.

FIG. 2: Surface of an embodiment of the bio-polymer mulch film according to the invention.

FIG. 3: Photograph of an embodiment of the bio-polymer mulch film according to the invention; the mulch film was used outdoors for 2 months.

FIG. 4: Photograph of an embodiment of the bio-polymer mulch film according to the invention; the mulch film was used outdoors for 2 months.

FIG. 5: Photograph of an embodiment of the bio-polymer mulch film according to the invention; the mulch film was used outdoors for 2 months.

FIG. 6: Tensile strengths of individual films.

FIG. 7: Ultimate elongation of individual films.

FIG. 8: Photograph of films from Example 11.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments, and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

As used herein the term “bio-polymer film” refers to a film made of a polymer or resin that meets the requirements as defined by ASTM D-6400 or ISO 17088:2008 or MOD or the European norm EN-13432 or the Japanese norm GreenPla or the norm of the province of Quebec CAN/BNQ 0017-088/2010 or any norm that provides for any soil-compostability and/or biodegradability, whether such bio-polymer is produced using renewable or non-renewable sources or a combination thereof.

As used herein the term “white on black bio-polymer mulch film” or similar term refers to a mulch film obtained by co-extrusion.

As used herein the term “black film coated with white pigment” or similar term refers to a film obtained by coating a black film with a white pigment.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, un-recited elements or process steps.

As used herein the term “about” is used to indicate that a value includes an inherent variation of error for the device or the method being employed to determine the value.

The inventors have discovered a process for manufacturing a bio-polymer mulch film that involves use of smaller amounts of bio-polymer material when used with a functional material. The process of the invention comprises a coating process. More specifically, the process of the invention comprises providing a coat of functional material on at least parts of a surface of a bio-polymer film.

The functional material may be a light absorber material, a light reflecting material, a pigment, or any suitable similar material, or a combination thereof. More specifically, the functional material may be selected from the group consisting of: nitrocellulose, polyamide, acrylic, titanium dioxide (TiO₂), barium sulfate (BaSO₄), carbon black, aluminum (Al), graphene, zein including genetically modified zein and non genetically modified zein, magnesium carbonate (MgCO₃), zinc oxide (ZnO), calcium carbonate (CaCO₃), kaolin, wax, a metallic pigment including an aluminum (Al) pigment (Grandal™ W170), a solvent and any suitable material.

The bio-polymer mulch film of the invention has an average thickness that is less than the thickness of a conventional mulch film or an uncoated bio-polymer mulch film. More specifically, the bio-polymer mulch film of the invention has an average thickness that is at least about 15% less than the thickness of an uncoated bio-polymer mulch film or a conventional mulch film with similar efficiency. In embodiments of the invention the average thickness of the bio-polymer mulch film may be between about 0.3 to 3 milli inch (0.3 to 3 mil).

The bio-polymer mulch film and the functional material are each independently of various colors. The color may be white, black, silver, blue, gray, green, brown, yellow, orange, red, or any other suitable color, or a combination thereof. The bio-polymer mulch film may also have its natural color. Also, the functional material may have its natural, unpigmented color. In embodiments of the invention, at least one of the bio-polymer mulch film and the functional material is un-colored.

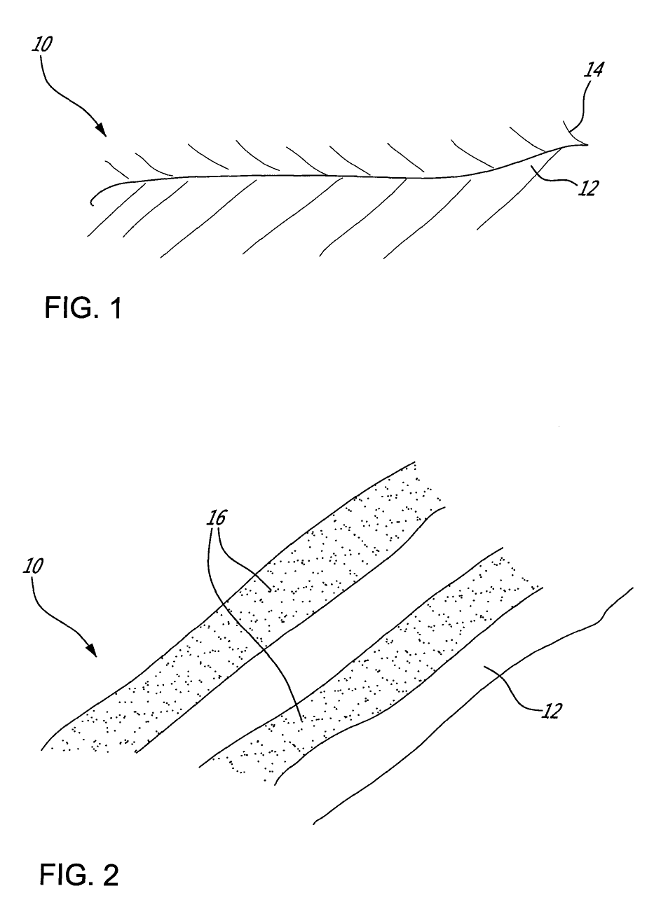

Referring to the figures, FIGS. 1 and 2 illustrate embodiments of the bio-polymer mulch film 10 according to the invention. The bio-polymer mulch film 10 comprises a layer of bio-polymer (bio-polymer film) 12. A coat of functional material 14 is provided on a surface of the bio-polymer film 12. In the embodiment illustrated in FIG. 1, the coat of functional material 14 is provided on the whole surface of the bio-polymer film 12. In an embodiment of the bio-polymer mulch film 10 as illustrated for example in FIG. 2, the coat of functional material 14 is provided in the form of stripes 16. As will be understood by a skilled person, the coat of functional material 14 may be provided in any other suitable form such that only parts of the surface of the bio-polymer film 12 is covered.

The present invention is illustrated in further details by the following non-limiting examples.

### Example 1—Application of a Black Coating on a Bio-Polymer Film

We propose to apply a coating of carbon black or other similar light absorber, be it inorganic and organic, on the surface of the film so as to protect or block sunlight from reaching the bio-polyester film. Consequently, the bio-polyester film will be thinner, contain as much or less carbon black, depending on the overall thickness. For example, a coating weight of 1 gram of carbon black per square meter is expected to allow for a 0.5 mil film to exhibit the same or better weathering properties as the Reference Film referred to herein above in the “Background” section.

The coating according to the invention may be applied using a common deposition method known in the art such as flexographic printing or equivalent or similar method, including roll-to-roll deposition techniques. This may involve a solvent or no solvent, and cured with heat, UV light or using an electron beam curing system.

It is expected that the thickness of the bio-polyester film may be reduced by about 15% while exhibiting equal or superior weathering properties as the Reference film, or other uncoated bio-polyester films known in the art, regardless of their thickness. Because bio-polyester materials are expensive, the additional cost of the coating and application thereto is inferior to the cost of a thicker and highly functionalized, uncoated film.

### Example 2—Application of a Coating of Pigment

We propose to apply a coating of titanium dioxide or other similar white pigment, for example, magnesium carbonate, zinc oxide, calcium carbonate, kaolin, aluminum powder, either in neat form or blended, on the surface of a black film so as to protect or block the Bio-polyester film from sunlight while reducing the temperature above the soil. Consequently, the bio-polyester film will be thinner. For example, a coating weight of 3 grams of titanium dioxide per square meter is expected to allow for a 0.5 mil film to exhibit superior properties as the Reference Film 2 (referred to herein above in the “Background” section) after it has been exposed to 4 months of sunlight, for example, in New Jersey. This, in turn, makes it suitable for use as a mulch film for solanacees like tomatoes, bell peppers and eggplant.

The coating according to the invention may be applied using a common deposition method known in the art such as flexographic printing, or equivalent or similar method, including roll-to-roll deposition techniques. This may involve a solvent or no solvent, and cured with heat, UV or an electron beam.

An advantage of such titanium dioxide coated films is their ability to be thinner yet perform as well after outside exposure if not better than thicker white on black co-extruded films. It is expected that the improvement may be in the order of at least about 15%, meaning that a 0.5 mil white coated film with a coat weight of 1 grams per square meter will perform at least as well as a 0.7 mil white on black film.

### Example 3—Application of a Matte White Coating

A black film coated with a white pigment, for example titanium dioxide, with a light coating weight (for instance, 1 or even 0.5 grams per square meter) is expected to not cause for as much sun damage to the young plants as a white on black co-extruded film. This will cause for less light reflection of light and still maintain a desired lower above soil temperature.

The process of the invention may be applied to a bio-polyester film or non-compostable film.

We have observed that the stems of young pepper plants do not harden as much, when planted over white coated films, as compared to a white on black films. It is believed that plants will grow taller and will be more productive.

### Example 4—Application of a White Coating on a Black Film

The following example illustrates this embodiment of the invention. On May 8 at 6.45 AM, soil temperatures were collected. The ambient air temperature was 57 F and it was foggy on that morning. The temperature of the black film, the white on black film, and the black film coated with white was 61.5 F (as measured with a temperature gun). The temperature 1.5 inches below the soil was 65.5 F for the black film, 64 F for the white on black film, and 64.5 F for the white-coated film (as measured with a thermal probe).

In contrast, on June 9, at 7 PM when the ambient temperature was 80 F, the temperature 1.5 inches below the soil was 73 F for the white on black film, as compared to 75 F for the white-coated black film and 76 F for the black film. As for the actual film temperatures, the white on black film temperature was also 73 F, whereas the temperature of the white-coated black film was 78 F and the black film was 81 F.

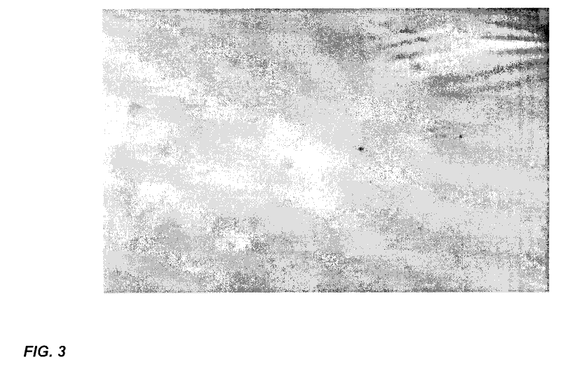

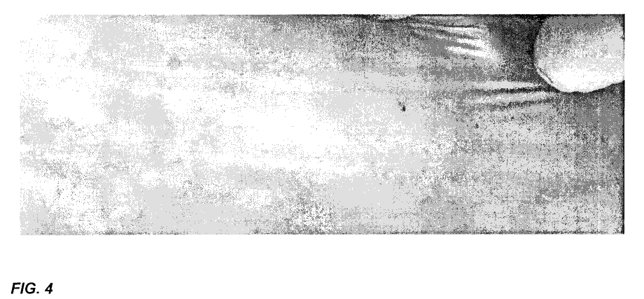

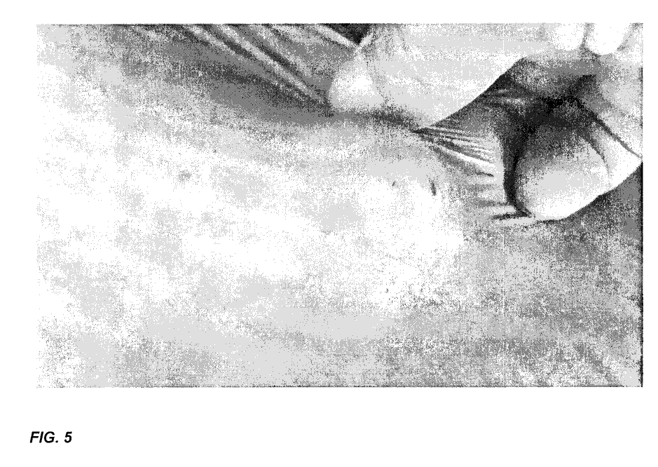

We have observed that a low relative reflectance white-coated black film maintains a sufficiently low air temperature and does not cause the stem to harden up; see FIGS. 3-5. In addition, we have observed warmer soil temperatures. The combination of these two seems to have increased early yield for peppers.

The coating according to the invention may be applied on the whole surface of the film or in stripes, so as to further increase the soil temperature where there is no coating; see FIGS. 3-5 and maintain the appropriate air temperature around the young plant.

The invention is further illustrated by more non-limiting examples as outlined below. These examples stem from experiments conducted in the spring and summer of 2016. Several bio-polymer films were produced using the blown film process. The films were then treated by applying various printing inks using the flexographic printing process. The films so treated were exposed outdoor for several weeks. The films were then tested for ultimate tensile strength and ultimate elongation using an Instron tensile tester. In all cases, the treated films exhibited more superior weather resistance than the untreated films.

### Example 5—Production of Films

Six films, P1 to P6 were produced using the same blown film extrusion equipment. The process involved substantially the same recipe for each film, namely, a mixture comprising polybutylene adipate terephthalate (PBAT), polylactic acid (PLA) and limestone. The amount of carbon black pigment varied slightly for each film and was generally up to about 3%. Also, the level of ultraviolet inhibitor incorporated varied slight for each film and was generally less than about 0.0005%. Table 1 below provides the characteristics for each of the P1 to P6 films produced.

TABLE 1
Characteristics of the films produced

| Film | | Average | |
|---|---|---|---|
| identification | Colour | thickness | Purpose |
| P1 | Black (3%) | 0.55 mil | Baseline (no treatment) |
| P2 | Black (3%) | 0.6 mil | Baseline (no treatment) |
| P3 | Clear, | 0.45 mil | Black treatment |
| | unpigmented | | |
| P4 | Black (3%) | 0.55 mil | White treatment |
| P5 | Black (3%) | 0.55 mil | White treatment |
| P6 | Black (3%) | 0.55 mil | Reflective treatment |

### Treatment of Films

Films were treated using a flexographic printing press and printing inks. The treatment comprises depositing ink on at least part of the surface of the film. In all cases, the amount of ink deposited was about 8 billion cubic microns (BCM).

### Example 6—Treated NP3 Film

Ink used for the NP3 film comprises nitrocellulose (2%), polyamide (53%), carbon black pigment (40%) and other suitable components including wax and additives (5%). The mixture is diluted in n-propanol (55%). The viscosity of the composition (Zahn Cup #2 EZ) is between about 20 and 24 seconds. The viscosity is kept at this level on the printing press by addition of n-propanol, as needed.

### Example 7—Treated BP4 and BP5 Films

Ink used for each of the BP4 and BP5 films comprises nitrocellulose (4%), polyamide (25%), wax (3%) and TiO₂ (68%). The mixture is diluted in n-propanol (40%). The viscosity of the composition (Zahn Cup #2 EZ) is between about 23 and 28 seconds. The viscosity is kept at this level on the printing press by addition of n-propanol, as needed.

### Example 8A—Treated SP6 Film (Zein (Genetically Modified), BaSO₄—Aluminum)

Ink composition for SP6 film comprises concentrated BaSO₄—Al (65%) and a solvent mix (35%). The two components mixed together under gentle stirring. First, the solvent mix is prepared, by mixing together n-propanol (70%) and water (30%) at room temperature under gentle stirring. This will be used at the various steps of the process.

The concentrated BaSO₄—Al is obtained by mixing together zein varnish at 30%, BaSO₄ (54%), Grandal™ W170 (Al) dough (15%) and the solvent mix (1%). The process at this step is as follows: BaSO₄ is incorporated into the zein varnish and dispersed at high speed; the temperature is monitored and maintained around about 50-55° C.; the Grandal W170 (Al) dough is then added, at moderate speed until a homogenous mixture is obtained.

The Grandal W170 (Al) dough is obtained by mixing together Grandal W170 (50%) and the solvent mix (50%), according to the following process: Grandal W170 granules are soaked into the solvent mix for about 30 minutes and the mixture subjected to gentle stirring at room temperature.

The zein varnish is obtained by mixing together genetically modified zein F4000 (30%) and the solvent mix (70%) under gentle stirring until a homogenous mixture is obtained.

In this embodiment of the invention, the metallic pigment Grandal W170 is used. As will be understood by a skilled person, other suitable metallic pigments may also be used. For example other aluminum (Al) pigments may be used.

Further details on the process are provided in Table 2 below including the amounts of each component for the preparation of 100 kg of ink. The physico-chemical characteristics of the ink obtained are outlined in Table 3.

TABLE 2
Treatment for the SP6 film (zein (genetically
modified), BaSO₄-Al)
1-Solvent Mix

| | % | for 100 kg |
|---|---|---|
| n-Propanol | 70 | 42 |
| Water | 30 | 18 |
| | 100 | 60 |

2-Zein varnish at 30%

| | % | for 100 kg |
|---|---|---|
| Solvent Mix | 70 | 16.4 |
| Zein F4000 (genetically | 30 | 7 |
| modified) | | |
| | 100 | 19.5 |

3-Grandal W170 dough (Al)

| | % | for 100 kg |
|---|---|---|
| Solvent Mix | 50 | 4.85 |
| Grandal W170 | 50 | 4.85 |
| | 100 | 9.7 |

4-BaSO₄-Al concentrated

| | % | for 100 kg |
|---|---|---|
| Zein varnish | 30 | 19.5 |
| BaSO₄ | 54 | 35.1 |
| Grandal W170 dough | 15 | 9.7 |
| Solvent Mix | 1 | 0.7 |
| | 100 | 65 |

5-Ink (final)

| | % | for 100 kg |
|---|---|---|
| BaSO₄-Al concentrated | 65 | 65 |
| Solvent Mix | 35 | 35 |
| | 100 | 100 |

TABLE 3
Physico-chemical characteristics
of the ink obtained

| Control | Specifications |
|---|---|
| Visco Zahn #2 EZ | 25-30 |
| (sec) | |
| Masse volumique | 1.28-1.30 |
| (g/mL) | |
| ES (%) | 45.0-46.5 |
| Reflectance 310 nm | 33-37 |
| (%)* | |
| Reflectance 380 nm | 32-36 |
| (%)* | |

*For a full surface printing at 8 BCM-240 LPI

### Example 8B—Treated NP6 Film (Zein (Non Genetically Modified), BaSO₄—Aluminum)

Ink for the PS6 film may be prepared using non genetically modified zein. The ink composition comprises concentrated BaSO₄—Al (65%) and a solvent mix (35%). The solvent mix is obtained by mixing together n-propanol (90%) and water (10%); and the concentrated BaSO₄—Al is obtained by mixing together zein varnish (30%), BaSO₄ (54%), Grandal W170 dough (15%) and the solvent mix (1%). The Grandal W170 dough is obtained by mixing together Grandal W170 (50%) and the solvent mix (50%); and the zein varnish is obtained by mixing together non genetically modified zein F4400 (30%) and the solvent mix (70%). The process is further outlined in Table 4 below. Details are generally as described in Example 8A above.

In this embodiment of the invention, the metallic pigment Grandal W170 is used. As will be understood by a skilled person, other suitable metallic pigments may also be used. For example other aluminum (Al) pigments may be used.

TABLE 4
Treatment for the SP6 film (zein (non genetically
modified), BaSO₄-Al)
1-Solvent Mix

| | % |
|---|---|
| n-Propanol | 90 |
| Water | 10 |
| | 100 |

2-Zein varnish at 30%

| | % |
|---|---|
| Solvent Mix | 70 |
| Zein F4400 (non genetically | 30 |
| modified) | |
| | 100 |

3-Grandal W170 dough (Al)

| | % |
|---|---|
| Solvent Mix | 50 |
| Grandal W170 | 50 |
| | 100 |

4-BaSO₄-Al concentrated

| | % |
|---|---|
| Zein varnish | 30 |
| BaSO₄ | 54 |
| Grandal W170 dough | 15 |
| Solvent Mix | 1 |
| | 100 |

5-Ink (final)

| | % |
|---|---|
| BaSO₄-Al concentrated | 65 |
| Solvent Mix | 35 |
| | 100 |

### Example 8C—Treated NP6 Film (Zein (Genetically Modified), BaSO₄—TiO₂)

Alternatively, ink for PS6 may comprise concentrated BaSO₄—TiO₂ (65%), zein varnish (20%) and a solvent mix (15%). The solvent mix is obtained by mixing together n-propanol (70%) and water (30%); zein varnish is obtained by mixing together genetically modified zein F4000 (30%); and the concentrated BaSO₄—TiO₂ is obtained by mixing together zein varnish (40%), BaSO₄ (42%), and TiO₂ (18%). The process is further outlined in Table 5 below. Details are generally as described in Example 8A above.

TABLE 5
Treatment for the SP6 film
(zein (genetically modified), BaSO₄-TiO₂)
1-Total Solvent

| | % |
|---|---|
| n-Propanol | 70 |
| Water | 30 |
| | 100 |

2-Zein varnish at 30%

| | % |
|---|---|
| Solvent | 70 |
| Zein F4000 (genetically | 30 |
| modified) | |
| | 100 |

3-BaSO₄-TiO₂ concentrated

| | % |
|---|---|
| Zein varnish | 40 |
| BaSO₄ | 42 |
| TiO₂ | 18 |
| | 100 |

4-Ink (final)

| | % |
|---|---|
| BaSO₄-TiO₂ concentrated | 65 |
| Zein varnish | 20 |
| Solvent | 15 |
| | 100 |

Treatment specifications for each film used in the experiments are outlined in Table 6 below.

TABLE 6
Treatment specification of films

| Film | Treated/ | Ink colour and | Pigment carrier | |
|---|---|---|---|---|
| identification | Untreated | pigment | type | Purpose |
| P1 | P1 (untreated) | none | not applicable | Baseline, unweathered |
| | | | (n.a.) | |
| P2 | P2 (untreated) | none | n.a. | Baseline, |
| | | | | unweathered |
| P3 | CP3 | none | n.a. | Baseline, weathered |
| | (untreated) | | | and compare to BP3 |
| P3 | NP3 (treated) | Black, carbon | Nitrocellulose and, | Effect of a black |
| | | black | optionally | coating and |
| | | | polyamide | comparison to CP3 |
| | | | or | |
| | | | acrylic | |
| P4 | BP4 (treated) | White, TiO₂ | Nitrocellulose and, | Effect of a white |
| | | | optionally | coating |
| | | | polyamide | |
| | | | or | |
| | | | acrylic | |
| P4 | NP4 | none | n.a. | Baseline, weathered |
| | (untreated) | | | and comparison to BP4 |
| P5 | BP5 (treated) | White, TiO₂ | Nitrocellulose and, | Effect of a white |
| | | | optionally | coating |
| | | | polyamide or | |
| | | | acrylic | |
| P5 | NP5 | none | n.a. | Baseline, weathered |
| | (untreated) | | | and comparison to BP5 |
| P6 | SP6 (treated) | Silver, BaSO₄-Al | Zein | Effect of a UV reflective |
| | | powder | | coating |

### Example 9—Outdoor Exposure

Films were exposed outdoors for a few weeks as outlined in Table 7 below. They were then removed and tested. The table provides the weathering data of each film. The test location and the duration of the exposure are also provided.

TABLE 7
Weathering specifications

| | | | | Total days |
|---|---|---|---|---|
| Film | | | | of outdoor |
| identification | Test site | Start date | End date | exposure |
| P1 | n.a. | none | none | 0 |
| P2 | n.a. | none | none | 0 |
| CP3 | Quebec | May 18, 2016 | Jun. 7, 2016 | 20 |
| NP3 | Quebec | May 18, 2016 | Jun. 7, 2016 | 20 |
| BP4 | Quebec | May 25, 2016 | Aug. 11, 2016 | 77 |
| NP4 | Quebec | May 25, 2016 | Aug. 11, 2016 | 77 |
| BP5 | New Jersey | May 18, 2016 | Aug. 17, 2016 | 90 |
| NP5 | New Jersey | May 18, 2016 | Aug. 17, 2016 | 90 |
| SP6 | Quebec | May 25, 2016 | Aug. 11, 2016 | 77 |

### Example 10—Tests

Films were then tested for their ultimate tensile strength and ultimate elongation strength, in the machine direction (MD), i.e., the direction in which the films are produced in extrusion, or the longitudinal direction; and in the transverse direction (TD), i.e., the direction perpendicular to which the films are produced in extrusion. This testing process is known in the art, generally referred to as “ASTM D882-12 Standard Test Method for Tensile Properties of Thin Sheeting.” The stretch speed used for all testing performed is 2 inches/minutes. The results obtained are outlined in Table 8 below.

TABLE 8
Test results for weathered and unweathered films

| | Tensile | Tensile | Max | Max |
|---|---|---|---|---|
| | Strength | Strength | Elongation | Elongation |
| Sample | MD (psi) | TD (psi) | MD (%) | TD (%) |
| P1 | 4641 | 2950 | 179 | 526 |
| P2 | 4978 | 4585 | 296 | 680 |
| CP3 | 3454 | 633 | 99 | <10 |
| NP3 | 4241 | 1514 | 72 | 20 |
| BP4 | 3182 | 1655 | 107 | 13 |
| NP4 | 2590 | 1545 | 59 | 15 |
| BP5 | 2235 | 1673 | 77 | 59 |
| NP5 | 2016 | 1364 | 15 | <10 |
| SP6 | 3125 | 1455 | 85 | 14 |

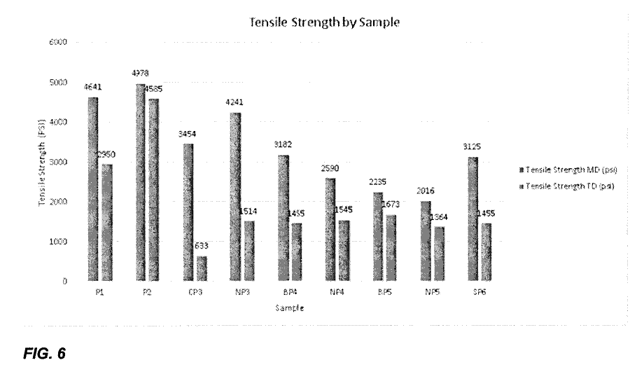

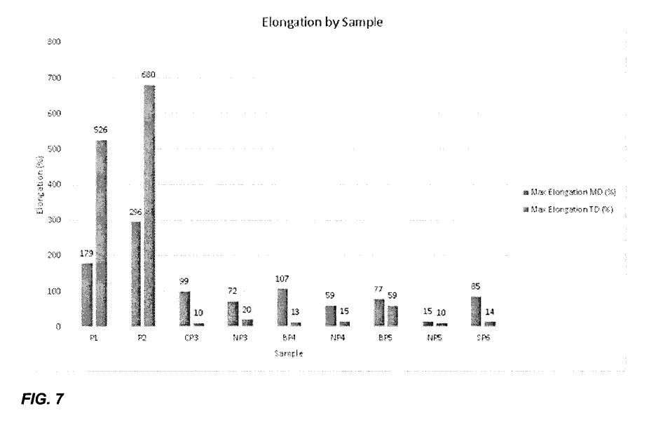

Graphical representations of the testing results are provided in FIG. 6 (ultimate tensile strengths) and FIG. 7 (ultimate elongation strengths). As will be understood by a skilled person, tensile strength data teaches us about the amount of energy required to break the film, and ultimate elongation strength data teaches us the capacity of the film to be pulled before breaking, given a certain pull speed (2 inches/minutes).

As can be seen from the results obtained outlined in Table 8, FIG. 6 and FIG. 7, all films exhibit superior tensile strength in the longitudinal direction (MD) than in the transverse direction (TD). Further comments are provided below based on a grouping of the films in the following three groups: 1—Films treated with white, TiO₂; 2—Films treated with carbon black; and 3—Films treated with reflective BaSO₄—Al.

Films Treated with White, TiO₂

Outdoor exposure of films has a general negative effect on the tensile strength of all films. In the MD, films NP4 and NP5, both untreated, each retained 56% and 43% of their strength, respectively as compared to the unweathered film P1. In contrast, treated films BP4 and BP5 retained 69% and 48% of their strength respectively, a gain of 23% and 12% respectively. In the TD, untreated films NP4 and NP5 retained 52% and 46% of their strength, respectively. In contrast, treated films BP4 and BP5 retained 56% and 57% of their strength, a gain of 8% and 24% respectively.

Outdoor exposure also has a general negative effect on the ultimate elongation. In the MD, films NP4 and NP5, both untreated, each retained 33% and 9% of their strength, respectively as compared to the unweathered film P1. In contrast, treated films BP4 and BP5 retained 60% and 43% of their strength respectively, a gain of 82% and 393% respectively. In the TD, untreated films NP4 and NP5 retained each about 3% of their strength. In contrast, treated films BP4 also retained 3% whereas BP5 retained 12%, about 4 times more than untreated films.

Films Treated with Carbon Black

Outdoor exposure of films has a general negative effect on the tensile strength of films. In the MD, untreated film CP3 retained 74% of its strength, whereas treated film BP3 retained 91% of its strength, a gain of 23%. In the TD, untreated film CP3 retained 21% of its strength whereas treated film NP3 retained 51% of its strength, which is more than double that of the untreated film. Regarding the ultimate elongation, in the MD, films untreated film CP3 and treated film NP3 behaved similar to one another.

Films Treated with Reflective BaSO₄—Aluminum

These films performed in a way similar to films treated with titanium dioxide. They retained 67% of MD strength, which is a 22% gain as compared to untreated films; 50% of TD strength (no gain) and; 47% of ultimate elongation in the MD, which is a 33% gain as compared to untreated and 3% ultimate elongation in the TD. These films were installed in the same test field as films BP4 and NP4.

Moreover, as can be seen from the results obtained and outlined above in Table 8, FIG. 6 and FIG. 7 that Coating films with titanium dioxide, carbon black and/or a mixture of barium sulfate and aluminum, whether in a nitrocellulose base, alone or combination with a polyamide or a zein base, interesting results are obtained. The ultimate tensile strength of weathered films yields gains in both the MD and TD directions. The ultimate elongation of such films yields gains for titanium dioxide and the barium sulfate and aluminum mixture in the MD direction. Generally, treated films were overall tougher than untreated films.

### Example 11—Experiments on Additional Films, R1 (Untreated) and R2 Film (Treated)

Two further films were produced and tested. The production method was as described above at Example 5. One film had a thickness of 0.9 mil (R1 film) and the other had a thickness of 0.7 mil including the coating (R2 film). The ink used in the coating of the R1 film is the same as describe above at Example 6 (varnish black on black). The two films were installed outdoor in Laval, Quebec on Jul. 5, 2016, and samples were collected on Aug. 29, 2016. A photograph is provided in FIG. 8. Testing was conducted in accordance with the ASTM D882-12 method referred to at Example 10 above. The results obtained show that a 25% lighter coated film resists UV deterioration better than an uncoated (heavier) film.

### INDUSTRIAL APPLICABILITY

There is provided a cost-effective process for manufacturing a bio-polymer mulch film. Indeed, the process involves use of smaller amounts of bio-polymer material and functional material. The bio-polymer of the invention has an average thickness that is at least about 15% less than the thickness of an uncoated bio-polymer mulch film or a conventional mulch film with similar efficiency.

Although the present invention has been described hereinabove by way of specific embodiments thereof, it may be modified, without departing from the spirit and nature of the subject invention as defined in the appended claims.

The present description refers to a number of documents, the content of which is herein incorporated by reference in their entirety.

1. A process for manufacturing a bio-polymer mulch film, comprising a step of coating at least parts of a surface of a bio-polymer film with a functional material.

2. (canceled)

3. A process according to claim 1, wherein the coating step is performed by a technique selected from the group consisting of: flexographic printing, coil printing, screen printing, rotogravure, lithography, ink-jet, roll-to-roll deposition technique, spraying technique and combinations thereof.

4. (canceled)

5. A process according to claim 1, further comprising:
a pre-treatment step wherein a charge is imparted on the surface of the bio-polymer film; optionally the pre-treatment step comprises at least of corona treatment, air plasma, flame plasma and chemical plasma system; and/or
a curing step; optionally, the curing step involves heat, UV light and/or an electron beam.

6. (canceled)

7. A process according to claim 1, wherein the functional material comprises a light absorber material, a light reflector material and/or a pigment; optionally the functional material comprises at least one of: nitrocellulose, polyamide, acrylic, polyurethane, rosin, titanium dioxide (TiO₂), barium sulfate (BaSO₄), carbon black, aluminum (Al), graphene, zein including genetically modified zein and non-genetically modified zein, magnesium carbonate (MgCO₃), zinc oxide (ZnO), calcium carbonate (CaCO₃), kaolin, wax, a metallic pigment including an aluminum (Al) pigment (Grandal™ W170), and a solvent.

8.-16. (canceled)

17. A process according to claim 1, wherein the functional material has a viscosity (Zahn Cup #2 EZ) between about 20 to 30 seconds, preferably about 23 to 28 seconds or about 25 to 30 seconds; optionally a solvent is added during the process to maintain the viscosity at a desired value.

18. A process according to claim 17, wherein the solvent comprises alcohol and/or water.

19. A process according to claim 1, wherein the coating is on the whole surface of the bio-polymer film.

20. A process according to claim 1, wherein the coating is in the form of one or more stripes on the surface of the bio-polymer film; optionally the stripes are continuous or discontinuous.

21. (canceled)

22. A process according to claim 1, wherein:
the coating is of a color selected from the group consisting of: white, black, silver, blue, gray, green, yellow, orange, red and a combination thereof; optionally the color is matte (reflectance below 55%); or
the coating has no color (no pigment).

23. (canceled)

24. A process according to claim 1, wherein:
the bio-polymer film is of a color selected from the group consisting of: white, black, silver, blue, gray, green, brown and a combination thereof; or
the bio-polymer film has its natural color.

25. (canceled)

26. A process according to claim 1, wherein:
the coated side of the bio-polymer film and the coating are each of a different color; or
the coated side of the bio-polymer film and the coating are of the same color; or
the coated side of bio-polymer film has a color and the coating has no color (no pigment); or
the bio-polymer film has no color and the coating has a color; or
the bio-polymer film has no color and the coating has no color (no pigment).

27.-31. (canceled)

32. A bio-polymer mulch film comprising a layer of bio-polymer material that is at least partially coated with a layer of a functional material.

33. A bio-polymer mulch film according to claim 32, having:
an average thickness that is at least about 15% less than an average thickness of an uncoated bio-polymer mulch film; and/or
an average thickness that is at least about 15% less than an average thickness of a conventional mulch film; and/or
an average thickness that is between about 0.3 to 3 mil.

34.-35. (canceled)

36. A method of controlling the temperature of the soil and air around a plant, comprising using a bio-polymer mulch film comprising a layer of bio-polymer material that is at least partially coated with a layer of a functional material.

37.-38. (canceled)

39. A method according to claim 36, wherein the use comprises covering the soil around the plant with the bio-polymer mulch film such that the surface of the mulch film having the coat of functional material is exposed to sunlight.

40. A composition comprising:
genetically modified zein, BaSO₄, Al and a solvent; optionally, the functional material comprises an Al pigment (Grandal W170); or
non genetically modified zein, BaSO₄, Al and a solvent; optionally, the functional material comprises an Al pigment (Grandal W170); or
genetically modified zein, BaSO₄, TiO₂ and a solvent; or
non-genetically modified zein, BaSO₄, TiO₂ and a solvent.

41.-47. (canceled)

48. A composition according to claim 40, wherein the solvent comprises an organic solvent including alcohol and/or water; preferably the solvent comprises a C₁-C₁₂ linear, branched, saturated or unsaturated organic solvent and/or water; more preferably the solvent comprises a C₁-C₁₂ linear, branched, saturated or unsaturated alcohol and/or water; more preferably the solvent comprises n-propanol and/or water.

49. A composition according to claim 48, wherein the solvent is selected from the group consisting of: n-propanol, n-propyl acetate, methanol, ethanol, ethyl acetate, methyl acetate, methoxy propyl acetate, 3-propoxypropan-1-ol (Propasol™ P), diacetone alcohol, ethoxypropanol and combinations thereof.

50.-51. (canceled)

52. A process for preparing a composition comprising zein, BaSO₄, Al and a solvent, the process comprising:
(a) providing a solvent comprising an organic solvent including alcohol and/or water;
(b) mixing zein with a first part of the solvent of step (a) to obtain varnish zein;
(c) mixing Al pellets with a second part of the solvent of step (a) to obtain a dough;
(d) mixing the varnish zein obtained at step (b), BaSO₄, Al, the dough obtained at step (c) and a third part of the solvent of step (a) to obtain a concentrated mixture; and
(e) mixing the concentrated mixture obtained at step (d) with a fourth part of the solvent of step (a) to obtain the composition.

53. A process for preparing a composition comprising zein, BaSO₄, TiO₂ and a solvent, the process comprising:
(a) providing a solvent comprising an organic solvent including alcohol and/or water;
(b) mixing zein with a first part of the solvent of step (a) to obtain varnish zein;
(c) mixing a first part of the varnish zein obtained at step (b), BaSO₄ and TiO₂ to obtain a concentrated mixture; and
(d) mixing the mixture obtained at step (c), a second part of the varnish zein obtained at step (b) and a second part of the solvent of step (a) to obtain the composition.

54. A process according to claim 52, wherein:
the solvent is obtained by gently stirring alcohol and/or water, preferably at room temperature and/or;
step (b) is carried out under gentle to moderate stirring, preferably until the varnish zein is a homogenous mixture; and/or
step (c) comprises (c1) soaking the Al pellets into the solvent, preferably during a period of about 30 minutes, and (c2) subjecting the mixture to a gentle stirring; preferably steps (c1) and (c2) are carried out at room temperature; and/or
step (e) is carried out under gentle to moderate stirring; and/or
step (e) is carried out under gentle to moderate stirring.

55.-59. (canceled)

60. A process according to claim 52, wherein:
the Al pellets at step (c) comprise Grandal W170; and/or
the Al at step (d) comprises finely grounded Al.

61. (canceled)
